(19) United States
(12) Patent Application Publication
(10) Pub. No.: US 2026/0089158 A1
(43) Pub. Date: Mar. 26, 2026

(54) WEB ACCESSIBILITY MONITORING AND CORRECTION USING AI

(71) Applicant: INTERNATIONAL BUSINESS MACHINES CORPORATION, Armonk, NY (US)

(72) Inventors: Willie L. Scott, II, Austin, TX (US); Michael Brooke Gower, Victoria (CA); Mary Jo Mueller, Austin, TX (US); Phillip D. Jenkins, Cedar Park, TX (US); Marc Kevin Johlic, Seminole, FL (US); Marnie Hoover, Cary, NC (US)

(21) Appl. No.: 18/896,869

(22) Filed: Sep. 25, 2024

(51) Int. Cl. H04L 9/40

(52) U.S. Cl. CPC H04L 63/10

(57) ABSTRACT

A computer hardware system includes one or more artificial intelligence (AI) foundation models. Using a collection agent, web accessibility incident data associated with web assets is scraped from a plurality of different sources. The web accessibility incident data is classified, by an AI classifier, into a plurality of differently-classified groups of data. Entities are extracted by an AI entity extractor from the plurality of differently-classified groups of data. Using a frequency analysis engine and from the extracted entities, a frequency distribution table is created that identifies how frequently types of non-compliance are contained within the web accessibility incident data. Using the frequency distribution table a web accessibility meta-analysis is generated by an ensemble engine, and the web accessibility meta-analysis is provided to an accessibility checker, which modifies the operations thereof. The one or more AI foundation models includes the AI classifier and the AI entity extractor.

### BACKGROUND

The present invention relates to identifying and correcting web accessibility problems with websites, and more specifically, employing artificial intelligence to real-time monitor web accessibility issues and to make corrections to websites.

Many public-facing websites have been deemed to be places of public accommodations. Consequently, websites must meet certain standards for accessibility. In particular, the website should be designed to provide content that is accessible to people with a wide range of disabilities.

An enterprise website can comprise thousands of different webpages and each webpage needs to be evaluated for a wide variety of different accessibility standards. Consequently, accessibility checkers are known software tools that have been used to analyze websites for compliance with web accessibility standards such as the Americans with Disability Action (ADA) and Web Content Accessibility Guidelines (WCAG).

However, the ADA can be interpreted differently in different jurisdictions. Additionally, the WCAG are only guidelines. Consequently, compliance with these guidelines do not necessarily insulate an enterprise from web accessibility complaints. The absence of clear, defined regulations for web accessibility in places of public accommodation can mean that different organizations and different industries may face different expectations pertaining to web accessibility. However, for an accessibility checker to work most effectively, the accessibility checker needs to know what standards are being most-frequently being applied and how those standards are being applied.

### SUMMARY

A method is performed by a computer hardware system including one or more artificial intelligence (AI) foundation models. Using a collection agent, web accessibility incident data associated with web assets is scraped from a plurality of different sources. The web accessibility incident data is classified, by an AI classifier, into a plurality of differently-classified groups of data. Entities are extracted by an AI entity extractor from the plurality of differently-classified groups of data. Using a frequency analysis engine and from the extracted entities, a frequency distribution table is created that identifies how frequently types of non-compliance are contained within the web accessibility incident data. Using the frequency distribution table a web accessibility meta-analysis is generated by an ensemble engine, and the web accessibility meta-analysis is provided to an accessibility checker, which modifies the operations thereof. The one or more AI foundation models includes the AI classifier and the AI entity extractor.

Additionally, the methodology includes the web accessibility incident data being classified by type of compliance violation. Additionally, the extracted entities include web accessibility standards contained within the web accessibility incident data. Using a AI summarizer a summary for each of the differently-classified groups of data is generated, and the web accessibility meta-analysis is generated using the summary for each of the differently-classified groups of data. Also, the one or more AI foundation models includes the AI summarizer. The entities extracted by the AI entity extractor are used by a web accessibility standards agent to identify documentation describing web accessibility standards associated with the entities, and the AI summarizer uses the documentation to generate the summary. A web asset analyzed by the accessibility checker is subsequently modified based upon an analysis performed by the accessibility checker, and the web asset is a publicly-accessible web page or portion thereof.

A computer hardware system includes one or more AI foundation models. The computer hardware fuzzy logic system includes a hardware processor configured to initiate the following operations. Using a collection agent, web accessibility incident data associated with web assets is scraped from a plurality of different sources. The web accessibility incident data is classified, by an AI classifier, into a plurality of differently-classified groups of data. Entities are extracted by an AI entity extractor from the plurality of differently-classified groups of data. Using a frequency analysis engine and from the extracted entities, a frequency distribution table is created that identifies how frequently types of non-compliance are contained within the web accessibility incident data. Using the frequency distribution table a web accessibility meta-analysis is generated by an ensemble engine, and the web accessibility meta-analysis is provided to an accessibility checker, which modifies the operations thereof. The one or more AI foundation models includes the AI classifier and the AI entity extractor.

Additionally, the system includes the web accessibility incident data being classified by type of compliance violation. Additionally, the extracted entities include web accessibility standards contained within the web accessibility incident data. Using a AI summarizer a summary for each of the differently-classified groups of data is generated, and the web accessibility meta-analysis is generated using the summary for each of the differently-classified groups of data. Also, the one or more AI foundation models includes the AI summarizer. The entities extracted by the AI entity extractor are used by a web accessibility standards agent to identify documentation describing web accessibility standards associated with the entities, and the AI summarizer uses the documentation to generate the summary. A web asset analyzed by the accessibility checker is subsequently modified based upon an analysis performed by the accessibility checker, and the web asset is a publicly-accessible web page or portion thereof.

A computer program product comprises a computer readable storage medium having stored therein program code. The program code, which when executed by a computer hardware system including one or more artificial intelligence (AI) foundation models, causes the computer hardware system to perform the following. Using a collection agent, web accessibility incident data associated with web assets is scraped from a plurality of different sources. The web accessibility incident data is classified, by an AI classifier, into a plurality of differently-classified groups of data. Entities are extracted by an AI entity extractor from the plurality of differently-classified groups of data. Using a frequency analysis engine and from the extracted entities, a frequency distribution table is created that identifies how frequently types of non-compliance are contained within the web accessibility incident data. Using the frequency distribution table a web accessibility meta-analysis is generated by an ensemble engine, and the web accessibility meta-analysis is provided to an accessibility checker, which modifies the operations thereof. The one or more AI foundation models includes the AI classifier and the AI entity extractor.

Additionally, the compute program product includes the web accessibility incident data being classified by type of compliance violation. Additionally, the extracted entities include web accessibility standards contained within the web accessibility incident data. Using a AI summarizer a summary for each of the differently-classified groups of data is generated, and the web accessibility meta-analysis is generated using the summary for each of the differently-classified groups of data. Also, the one or more AI foundation models includes the AI summarizer. The entities extracted by the AI entity extractor are used by a web accessibility standards agent to identify documentation describing web accessibility standards associated with the entities, and the AI summarizer uses the documentation to generate the summary. A web asset analyzed by the accessibility checker is subsequently modified based upon an analysis performed by the accessibility checker, and the web asset is a publicly-accessible web page or portion thereof.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 is a block diagram illustrating an example architecture of a web accessibility evaluation system according to an embodiment of the present invention.

FIG. 2 is a block diagram illustrating a methodology of performing monitoring of web accessibility incidents and correcting web assets using the architecture of FIG. 1 according to an embodiment of the present invention.

FIG. 3 is an exemplary screenshot illustrating a graphical user interface of an accessibility checker launching a modal dialogue for configuring settings according to an embodiment of the present invention.

FIG. 4 is an exemplary screenshot illustrating a graphical user interface of an accessibility checker identifying web accessibility violations and risk levels according to an embodiment of the present invention.

FIG. 5 is an exemplary screenshot illustrating a graphical user interface of an accessibility checker displaying AI-generated insights for a particular web accessibility violation according to an embodiment of the present invention.

FIG. 6 is pseudocode for an improved accessibility checker rule according to an embodiment of the present invention.

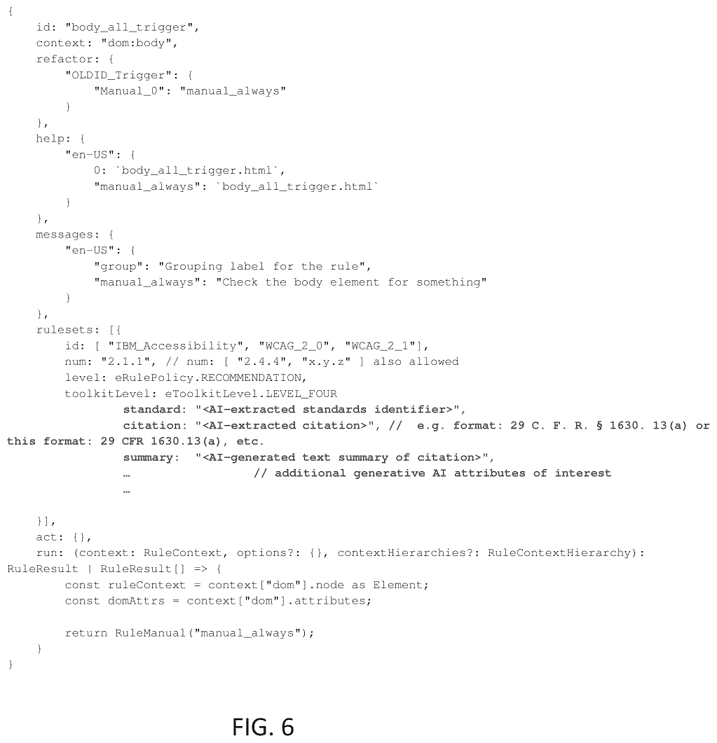

FIG. 7 is pseudocode illustrating how the frequency distribution is mapped and used by the accessibility checker according to an embodiment of the present invention.

FIGS. 8A and 8B are pseudocode, respectively, of a ruleset of the accessibility checker and data returned to the accessibility checker according to an embodiment of the present invention.

FIG. 9 is a block diagram illustrating an example of a computer environment for implementing portions of the methodology of FIG. 2.

### DETAILED DESCRIPTION

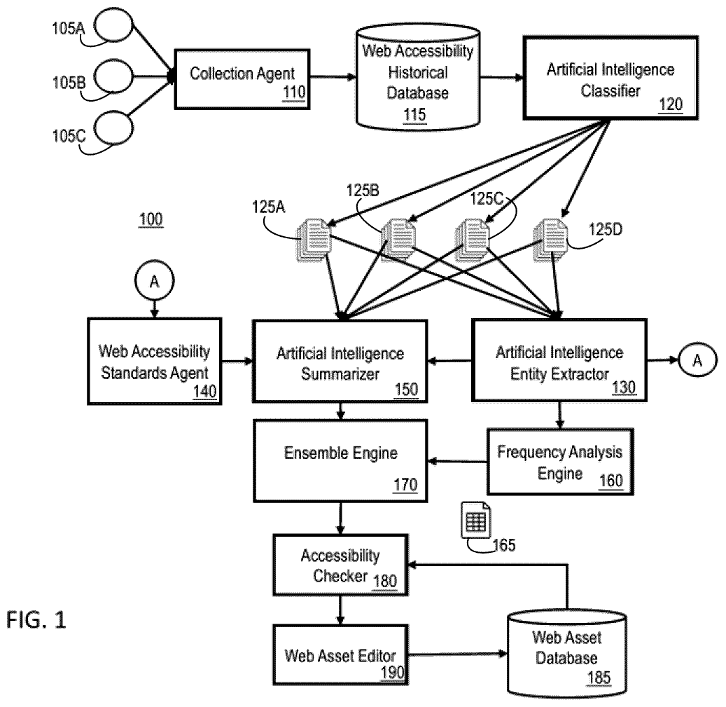

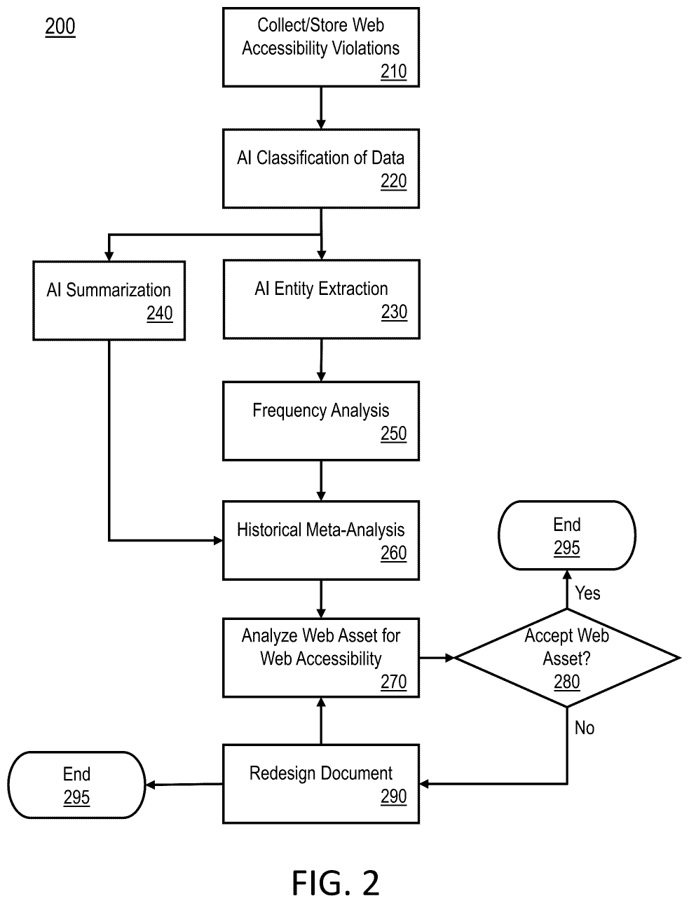

Referring to FIGS. 1 and 2, an exemplary web accessibility evaluation system 100 and methodology 200 of using the same are illustrated. In general, the methodology 200 employs one or more artificial intelligence (AI) foundation models 120, 130, 150 to perform the following. Using a collection agent 110, web accessibility incident data associated with web assets is scraped from a plurality of different sources 105A-C. The web accessibility incident data is classified, by an AI classifier 120, into a plurality of differently-classified groups of data 125A-D. Entities are extracted by an AI entity extractor 130 from the plurality of differently-classified groups of data 125A-D. Using a frequency analysis engine 160 and from the extracted entities, a frequency distribution table 165 is created that identifies how frequently types of non-compliance are contained within the web accessibility incident data. Using the frequency distribution table 165, a web accessibility meta-analysis is generated by an ensemble engine 170, and the web accessibility meta-analysis is provided to an accessibility checker 180, which is used to modify the operations thereof. The one or more AI foundation models 120, 130, 150 includes the AI classifier 120 and the AI entity extractor 130. As the term is used herein, “web asset” is defined as a publicly-accessible web page (or portion thereof).

In prior accessibility checkers, users have no in-context method to understand how frequently types of non-compliance are contained within the web accessibility incident data across a plurality of accessibility checker invocations and run against a plurality of web applications. Consequently, past accessibility checkers have been unable to provide insights for prioritizing web accessibility issues by frequency of occurrence. The present web accessibility evaluation system 100 improves upon past approaches by, for example, employing one or more AI foundation models are employed to prioritize web accessibility issues by frequency distribution. Additionally, the disclosed methodology 200 includes the web accessibility incident data being classified by type of compliance violation as well as extracting entities including web accessibility standards contained within the web accessibility incident data using then AI summarizer 150 for generating a summary for each of the differently-classified groups of data that is generated. The AI summarizer 150 can also use past documentation to generate a summary of associated web accessibility standards.

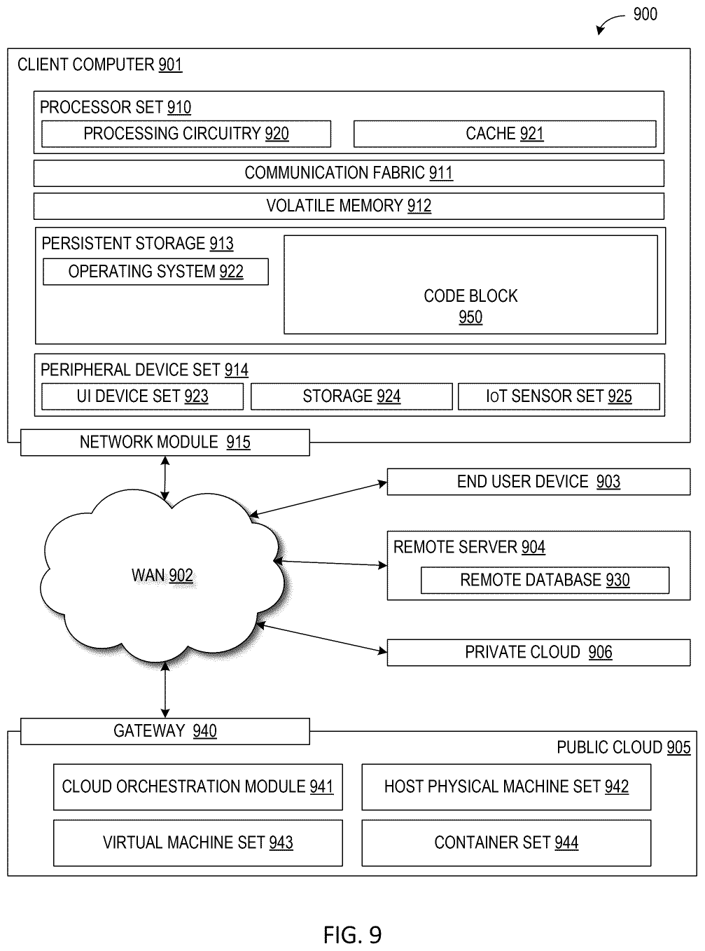

Although not limited in this manner, the web accessibility evaluation system 100 includes a number of components including a collection agent 110, web accessibility historical database 115, artificial intelligence (AI) classifier 120, AI intelligence summarizer 150, AI entity extractor 130, web accessibility standards agent 140, ensemble engine 170, frequency analysis engine 160, accessibility checker 180, web asset database 185, and web asset editor 190. Although these components are illustrated as being separate components, one or more of these components can be integrated together and/or provided as software as a service, as further described with regard to FIG. 9.

The AI classifier 120, AI summarizer 150, and the AI entity extractor 130 can be separate entities or combined. Additionally, these AI components 120, 130, 150 can employ one or more AI foundation models for generative AI. A foundation model can be referred to as a “general purpose AI” or “GPAI” system and can be capable of a range of general tasks such as text prediction/synthesis, image manipulation/generation, and audio generation. An illustrative example of an AI foundation model is watsonX.ai technologies.

Additionally, the accessibility checker 180, web asset editor 190, and web asset database 185 can be client-based with the remainder of the components of the web accessibility evaluation system 100 can be server-based and/or provided as part of a software as a service.

With specific reference to FIG. 2, an overview of the general process 200 for employing the web accessibility evaluation system 100 is disclosed. In 210, the web accessibility historical database 115 stores data indicative of web accessibility incidents identified and collected by the collection agent 110. As defined herein, a “web accessibility incident” is one in which a particular web asset/website/software application was identified as not conforming with one or more web accessibility standards. The collection agent 110 is not limited as to a particular type or a particular methodology by which the collection agent 110 operates. The collection agent 110 could be, for example, a specialized internet (or Web) scraper that searches (scrapes) multiple sources 105A-C on the internet for information/data indicative of web accessibility incidents. This information could be found, for example, in a news article describing the web accessibility violation. As another example, the information could be found in user feedback. In yet another example, the information could be found in legal documents associated with a suit brought against an owner of a particular web asset/website/software application.

The format in which the web accessibility incident information and subsequently stored is not limited. For example, the collection agent 110 could obtain the web accessibility incident data as either structured or unstructured data, and this data could be stored in the same format. Alternatively, if the web accessibility incident data is collected as unstructured data, the collection agent 110 can be configured to convert the unstructured data into structured data using known techniques.

In 220, the AI classifier 120, leveraging text classification, is configured to classify the web accessibility incident data found within the web accessibility historical database 115 into a plurality of differently-classified groups (or clusters) of data 125A-D. The manner in which the data is classified by the AI classifier 120 is not limited as to a particular approach. For example, the data could be classified into groups of data 125A-D based upon topics, type of compliance violations, standards, etc. AI classifiers 120 are known technology, and the present web accessibility evaluation system 100 is not limited as to a particular type of AI classifier 120. An example of an AI classifier 120 is WatsonX.ai Classify.

In 230 and 240, the differently-classified groups of data 125A-D are respectively fed into an AI entity extractor 130 and AI summarizer 150. The operations performed by the AI entity extractor 130 and AI summarizer 150 can be performed serially and/or in parallel. Specifically, in 230, the AI entity extractor 130 identifies, within a particular group of data (e.g., 125A), the standards, regulations, paragraphs, subsections of the civil laws in non-compliance from the lawsuits (collectively referred to as “web accessibility standards”). An example of an AI entity extractor 130 is WatsonX.ai Extract.

Similar in operation to the collection agent 110, the web accessibility standards agent 140 is configured to collect to data regarding web accessibility standards. These standards can be optional standards, such as those set forth in the WCAG, as well as mandatory standards, such as those associated with the ADA. Additionally, the web accessibility standards agent 140 can leverage data from the AI entity extractor 130 to identify particular standards contained within the differently-classified groups of data 125A-D. The data regarding web accessibility standards can then be provided by the web accessibility standards agent 140 to the AI summarizer 150.

In 240, the AI summarizer 150 summarizes the differently-classified groups of data 125A-D. In particular, the AI summarizer 150 can employ a foundation model that is trained to summarize complex documents. Additionally, the AI summarizer 150 can summarize the data regarding web accessibility standards provided by the web accessibility standards agent 140. These summaries can be mapped to specific web accessibility standards identified by the AI entity extractor 130. An example of an AI summarizer 150 is WatsonX.ai Summarize.

In 250, the frequency analysis engine 160 is configured to perform an automated frequency analysis across the groupings of data 125A-D. In particular, the frequency analysis engine 160 is configured to extract standards, regulations, paragraphs, and subsections of code that have been cited in asserting that particular web assets have been asserted are non-compliant. Additionally, the frequency analysis engine 160 can be configured to identify short-and/or long-term trends of non-compliance with regard to types of web assets and/or types of non-compliance.

The frequency analysis engine is also configured to generate a frequency distribution table 165, which is a data structure that identifies particular types of non-compliance and identifies how frequently that types of non-compliance are cited in the web accessibility incident data. For example, for a particular standard associated with an accessibility compliance violation, the frequency table may include a quantitative (e.g., frequency or raw data) and/or qualitative measure (e.g., low, medium, high), and calculations are made to identify trends. Additionally, the frequency distribution table can identify particular entities that are alleging non-compliance and the number of times in which these entities have alleged non-compliance with accessibility standards.

In 260, the ensemble engine 170 performs a historical meta-analysis based upon the data provided by the AI summarizer 150 and the frequency analysis engine 160. Using insights generated from the AI-based groupings of data 125A-D from 240, entity extraction from 230, and the frequency analysis from 250, the ensemble engine 170 is configured to deliver, as part of a web accessibility meta-analysis, dynamic, data driven insights on frequently occurring areas for web accessibility disputes in addition to plain language summaries of the disputes and cited standards.

In 270, using the historical meta-analysis provided in 260 by the ensemble engine 170, an accessibility checker 180 analyzes the web asset for accessibility compliance. In certain aspects, the accessibility checker 180 leverages data from the frequency table 165 in performing the compliance checking. For example, the accessibility checker 180 can focus computational efforts on those portions of the web asset identified as being most at risk for compliance efforts. Additionally, upon non-compliant portions of the web asset being identified by the accessibility checker 180, the accessibility checker 180 can link the type of web asset to a lookup key in the frequency distribution table 165, and pertinent information about risk regarding the non-compliant portions of the web asset can be returned to the accessibility checker 180 and subsequently surfaced to a user.

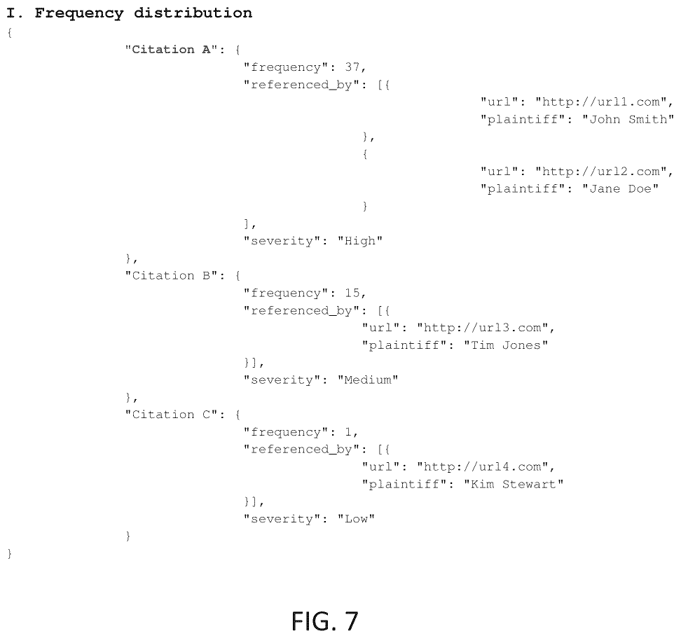

Results of the automated accessibility checker 180 can be used to define a mapping between accessibility violations and the corresponding standard/regulations referenced by the accessibility legislation citations. Additionally, this operation can be performed programmatically and on a scheduled basis to keep the mapping current. The accessibility checker 180 is improved enhanced to consume AI-augmented “rules metadata” which is used to flag accessibility violations in a web asset. When using the accessibility checker 180 to evaluate a web asset, rules and associated metadata are used to determine which accessibility violations, if any, are surfaced in the application. Additionally, existing rules technologies is improved to include pertinent data that has been extracted using the AI foundation models 120, 130, 150 including but not limited to specific standards, regulations, paragraphs, and summaries of subsections of the laws. Examples of rules metadata include rule object, messages, help, and test cases. An example of a rule for an accessibility checker 180 is illustrated in FIG. 7.

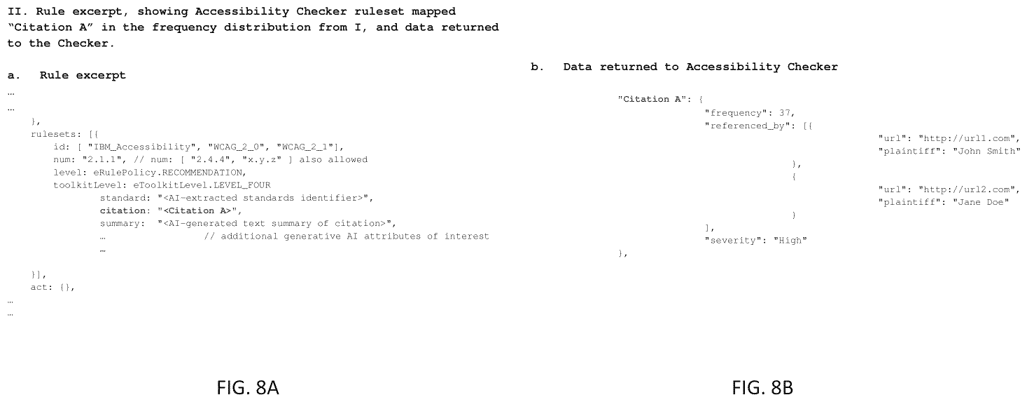

Additionally, pseudocode illustrating how the frequency distribution is mapped and used by the accessibility checker 180 is illustrated in FIG. 7, which describes frequency distribution. Additionally, FIGS. 8A and 8B respectively illustrate pseudocode of a ruleset of the accessibility checker 180 mapped to a “Citation A” and the data returned to the accessibility checker 180.

In 280, a determination is made whether to accept the web asset. In certain aspects, this can be performed manually or automatically. In certain instances, the accessibility checker 180 will allow a web asset to be approved (accepted) even if accessibility issues are found in the web asset. In other instances, however, the accessibility checker 180 will not allow a web asset to be approved depending upon the accessibility issue identified by the accessibility checker 180. For example and with reference to the example provided in the FIGS. 8A and 8B, “Citation A” maps to a “severity=High” violation due to a relatively high frequency occurrence of citations in compliance actions. In this instance, because of this high frequency, the particular accessibility issue must be corrected prior to the web asset being accepted. If the web asset is accepted, the process 200 proceeds to 295, in which the process 200 ends or the process 200 proceeds to evaluate a different web asset in 270.

In 290, if a determination is made in 280 not to accept the web asset, the process proceeds to 290 in which the web asset is redesigned/replaced using the web asset editor 190 based upon the web accessibility issues identified in 270. After the web asset has been redesigned/replaced, the web asset can be placed within the web asset database 185.

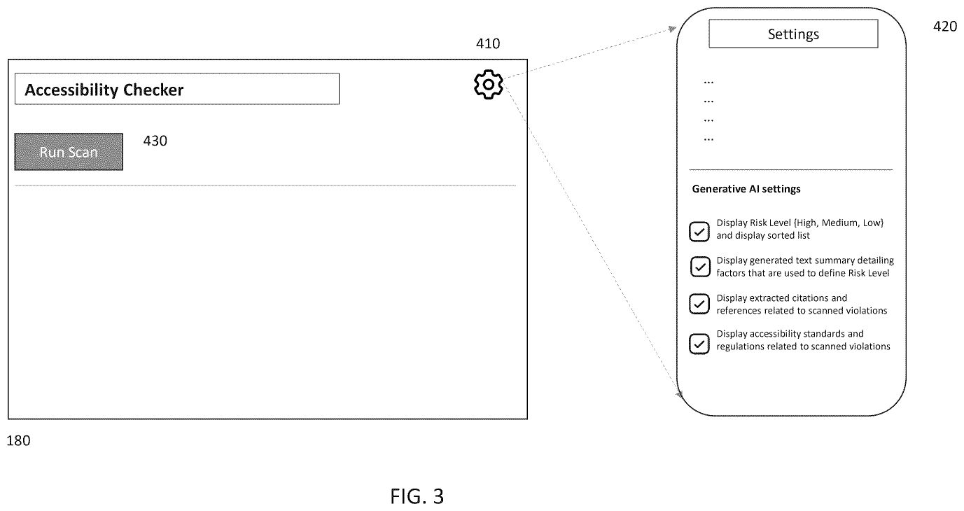

Referring to FIGS. 3-5, exemplary operations implemented by the improved accessibility checker 180 and enabled by the web accessibility evaluation system 100 are illustrated. Referring to FIG. 3, and prior to an accessibility scan of a software application is executed, a user can select, via a settings user control (e.g., gear icon 410), to launch a modal dialogue user interface 420 that allows a user to configure settings to enable generative AI improvements to the accessibility checker 180 technology.

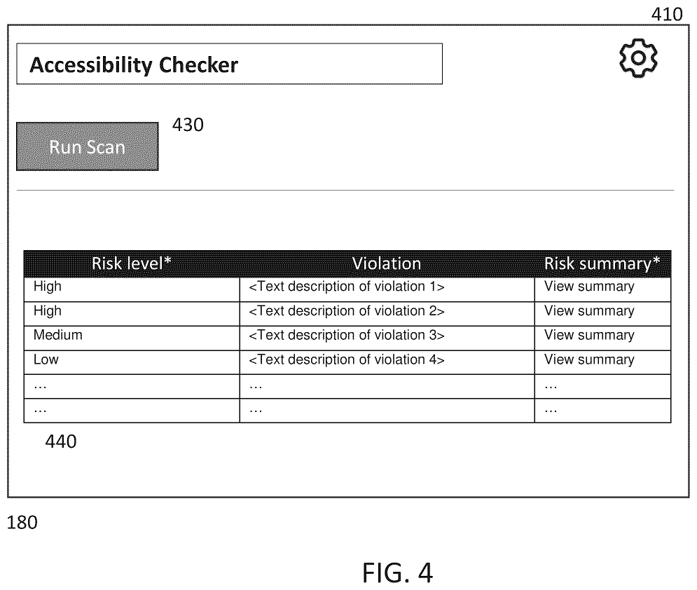

Referring to FIG. 4, after the user has enabled generative AI improvements to the accessibility checker 180 technology in settings, and the scan of the software application can be implemented (e.g., clicking on the “Ran Scan” user control 430). As discussed in more detail regarding operation 270 in FIG. 2, the accessibility checker 180 identifies web accessibility violations within the software application. The particular web accessibility violations can be presented to a user via the accessibility checker 180. Additionally, the accessibility checker 180 can presented generative AI enabled features such as risk level (e.g., corresponding to the frequency distribution that maps accessibility violations to low, medium), and an identification of the particular violation (e.g., identifying the particular standard that has been violated). Additionally, the user can be presented by additional information regarding the particularly-identified violation (e.g., by selecting “View Summary”).

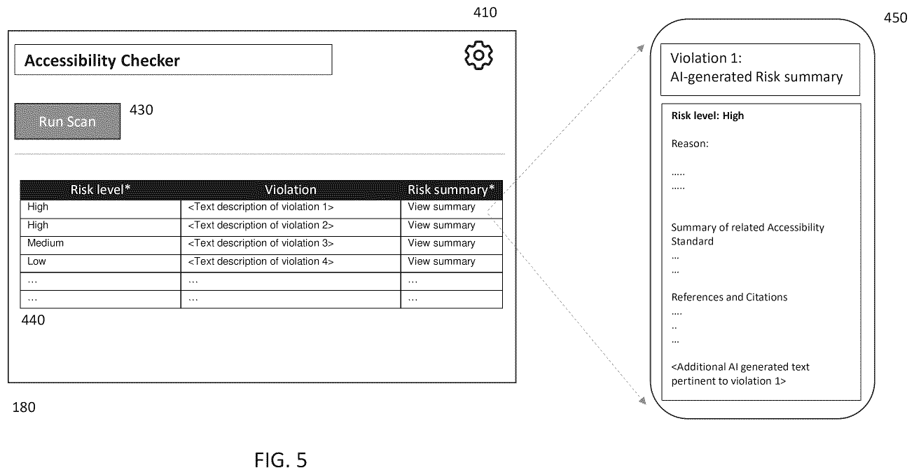

Referring to FIG. 5, after the user has selected to be presented with additional information, the accessibility checker 180 can present to the user a summary user interface 450. The summary user interface 450 can provide information such as risk level and reasons therefor, plain language text summaries of pertinent parts of regulations and standards, plain language text summaries of citations and references, and any additional information that is pertinent to the accessibility violation.

As defined herein, the term “responsive to” means responding or reacting readily to an action or event. Thus, if a second action is performed “responsive to” a first action, there is a causal relationship between an occurrence of the first action and an occurrence of the second action, and the term “responsive to”indicates such causal relationship.

As defined herein, the term “real time” means a level of processing responsiveness that a user or system senses as sufficiently immediate for a particular process or determination to be made, or that enables the processor to keep up with some external process.

As defined herein, the term “automatically” means without user intervention.

Referring to FIG. 9, computing environment 900 contains an example of an environment for the execution of at least some of the computer code involved in performing the inventive methods, such as code block 950 for implementing the operations of the web accessibility evaluation system 100. Computing environment 900 includes, for example, computer 901, wide area network (WAN) 902, end user device (EUD) 903, remote server 904, public cloud 905, and private cloud 906. In certain aspects, computer 901 includes processor set 910 (including processing circuitry 920 and cache 921), communication fabric 911, volatile memory 912, persistent storage 913 (including operating system 922 and method code block 950), peripheral device set 914 (including user interface (UI), device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

Computer 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. However, to simplify this presentation of computing environment 900, detailed discussion is focused on a single computer, specifically computer 901. Computer 901 may or may not be located in a cloud, even though it is not shown in a cloud in FIG. 9 except to any extent as may be affirmatively indicated.

Processor set 910 includes one, or more, computer processors of any type now known or to be developed in the future. As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In certain computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods discussed above in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods may be stored in code block 950 in persistent storage 913.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible, hardware device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Communication fabric 911 is the signal conduction paths that allow the various components of computer 901 to communicate with each other. Typically, this communication fabric 911 is made of switches and electrically conductive paths, such as the switches and electrically conductive paths that make up busses, bridges, physical input/output ports and the like. Other types of signal communication paths may be used for the communication fabric 911, such as fiber optic communication paths and/or wireless communication paths.

Volatile memory 912 is any type of volatile memory now known or to be developed in the future. Examples include dynamic type random access memory (RAM) or static type RAM. Typically, the volatile memory 912 is characterized by random access, but this is not required unless affirmatively indicated. In computer 901, the volatile memory 912 is located in a single package and is internal to computer 901. In addition to alternatively, the volatile memory 912 may be distributed over multiple packages and/or located externally with respect to computer 901.

Persistent storage 913 is any form of non-volatile storage for computers that is now known or to be developed in the future. The non-volatility of the persistent storage 913 means that the stored data is maintained regardless of whether power is being supplied to computer 901 and/or directly to persistent storage 913. Persistent storage 913 may be a read only memory (ROM), but typically at least a portion of the persistent storage 913 allows writing of data, deletion of data and re-writing of data. Some familiar forms of persistent storage 913 include magnetic disks and solid state storage devices. Operating system 922 may take several forms, such as various known proprietary operating systems or open source Portable Operating System Interface type operating systems that employ a kernel. The code included in code block 950 typically includes at least some of the computer code involved in performing the inventive methods.

Peripheral device set 914 includes the set of peripheral devices for computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet.

In various aspects, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some aspects, storage 924 may take the form of a quantum computing storage device for storing data in the form of qubits. In aspects where computer 901 is required to have a large amount of storage (for example, where computer 901 locally stores and manages a large database) then this storage 924 may be provided by peripheral storage devices designed for storing very large amounts of data, such as a storage area network (SAN) that is shared by multiple, geographically distributed computers. Internet-of-Things (IoT) sensor set 925 is made up of sensors that can be used in IoT applications. For example, one sensor may be a thermometer and another sensor may be a motion detector.

Network module 915 is the collection of computer software, hardware, and firmware that allows computer 901 to communicate with other computers through a Wide Area Network (WAN) 902. Network module 915 may include hardware, such as modems or Wi-Fi signal transceivers, software for packetizing and/or de-packetizing data for communication network transmission, and/or web browser software for communicating data over the internet. In certain aspects, network control functions and network forwarding functions of network module 915 are performed on the same physical hardware device. In other aspects (for example, aspects that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any Wide Area Network (for example, the internet) capable of communicating computer data over non-local distances by any technology for communicating computer data, now known or to be developed in the future. In some aspects, the WAN 902 ay be replaced and/or supplemented by local area networks (LANs) designed to communicate data between devices located in a local area, such as a Wi-Fi network. The WAN 902 and/or LANs typically include computer hardware such as copper transmission cables, optical transmission fibers, wireless transmission, routers, firewalls, switches, gateway computers and edge servers.

End user device (EUD) 903 is any computer system that is used and controlled by an end user (for example, a customer of an enterprise that operates computer 901), and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In certain aspects, EUD 903 may be a client device, such as thin client, heavy client, mainframe computer, desktop computer and so on.

As defined herein, the term “client device” means a data processing system that requests shared services from a server, and with which a user directly interacts. Examples of a client device include, but are not limited to, a workstation, a desktop computer, a computer terminal, a mobile computer, a laptop computer, a netbook computer, a tablet computer, a smart phone, a personal digital assistant, a smart watch, smart glasses, a gaming device, a set-top box, a smart television and the like. Network infrastructure, such as routers, firewalls, switches, access points and the like, are not client devices as the term “client device” is defined herein. As defined herein, the term “user” means a person (i.e., a human being).

Remote server 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904. As defined herein, the term “server” means a data processing system configured to share services with one or more other data processing systems.

Public cloud 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

VCEs can be stored as “images,” and a new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 906 is similar to public cloud 905, except that the computing resources are only available for use by a single enterprise. While private cloud 906 is depicted as being in communication with WAN 902, in other aspects, a private cloud 906 may be disconnected from the internet entirely (e.g., WAN 902) and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this aspect, public cloud 905 and private cloud 906 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

As another example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. Each block in the flowchart or block diagrams may represent a module, segment, or portion of instructions, which comprises one or more executable instructions for implementing the specified logical function(s).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” “one arrangement,” “an arrangement,” “one aspect,” “an aspect,” or similar language means that a particular feature, structure, or characteristic described in connection with the embodiment is included in at least one embodiment described within this disclosure. Thus, appearances of the phrases “one embodiment,” “an embodiment,” “one arrangement,” “an arrangement,” “one aspect,” “an aspect,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “if,” “when,” “upon,” “in response to,” and the like are not to be construed as indicating a particular operation is optional. Rather, use of these terms indicate that a particular operation is conditional. For example and by way of a hypothetical, the language of “performing operation A upon B” does not indicate that operation A is optional. Rather, this language indicates that operation A is conditioned upon B occurring.

The foregoing description is just an example of embodiments of the invention, and variations and substitutions. While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

What is claimed is:

1. A computer-implemented method including one or more artificial intelligence (AI) foundation models, comprising:
scraping, from a plurality of different sources and using a collection agent, web accessibility incident data associated with web assets;
classifying, by an AI classifier, the web accessibility incident data into a plurality of differently-classified groups of data;
extracting, by an AI entity extractor, entities from the plurality of differently-classified groups of data;
creating, using a frequency analysis engine and from the extracted entities, a frequency distribution table identifying how frequently types of non-compliance are contained within the web accessibility incident data;
generating, using the frequency distribution table and by an ensemble engine, a web accessibility meta-analysis; and
providing the web accessibility meta-analysis to an accessibility checker, wherein the web accessibility meta-analysis is used to modify operations of the accessibility checker, and
the one or more AI foundation models includes the AI classifier and the AI entity extractor.

2. The method of claim 1, wherein
the web accessibility incident data is classified by type of compliance violation.

3. The method of claim 1, wherein
the extracted entities include web accessibility standards contained within the web accessibility incident data.

4. The method of claim 1, further comprising
generating, using a AI summarizer, a summary for each of the plurality of differently-classified groups of data, wherein
the web accessibility meta-analysis is generated using the summary for each of the differently-classified groups of data, and
the one or more AI foundation models includes the AI summarizer.

5. The method of claim 4, wherein
the entities extracted by the AI entity extractor are used by a web accessibility standards agent to identify documentation describing web accessibility standards associated with the entities, and
the AI summarizer uses the documentation to generate the summary.

6. The method of claim 1, wherein
a web asset analyzed by the accessibility checker is subsequently modified based upon an analysis performed by the accessibility checker.

7. The method of claim 1, wherein
a web asset is a publicly-accessible web page or portion thereof.

8. A computer hardware system including one or more artificial intelligence (AI) foundation models, comprising:
a hardware processor configured to initiate the following executable operations:
scraping, from a plurality of different sources and using a collection agent, web accessibility incident data associated with web assets;
classifying, by an AI classifier, the web accessibility incident data into a plurality of differently-classified groups of data;
extracting, by an AI entity extractor, entities from the plurality of differently-classified groups of data;
creating, using a frequency analysis engine and from the extracted entities, a frequency distribution table identifying how frequently types of non-compliance are contained within the web accessibility incident data;
generating, using the frequency distribution table and by an ensemble engine, a web accessibility meta-analysis; and
providing the web accessibility meta-analysis to an accessibility checker, wherein
the web accessibility meta-analysis is used to modify operations of the accessibility checker, and
the one or more AI foundation models includes the AI classifier and the AI entity extractor.

9. The system of claim 8, wherein
the web accessibility incident data is classified by type of compliance violation.

10. The system of claim 8, wherein
the extracted entities include web accessibility standards contained within the web accessibility incident data.

11. The system of claim 8, wherein the hardware processor is further configured to initiate the following executable operation:
generating, using a AI summarizer, a summary for each of the plurality of differently-classified groups of data, wherein
the web accessibility meta-analysis is generated using the summary for each of the differently-classified groups of data, and
the one or more AI foundation models includes the AI summarizer.

12. The system of claim 11, wherein
the entities extracted by the AI entity extractor are used by a web accessibility standards agent to identify documentation describing web accessibility standards associated with the entities, and
the AI summarizer uses the documentation to generate the summary.

13. The system of claim 8, wherein
a web asset analyzed by the accessibility checker is subsequently modified based upon an analysis performed by the accessibility checker.

14. The system of claim 8, wherein a web asset is a publicly-accessible web page or portion thereof.

15. A computer program product, comprising:
a computer readable storage medium having stored therein program code,
the program code, which when executed by a computer hardware system including one or more artificial intelligence (AI) foundation models, causes the computer hardware system to perform:
scraping, from a plurality of different sources and using a collection agent, web accessibility incident data associated with web assets;
classifying, by an AI classifier, the web accessibility incident data into a plurality of differently-classified groups of data;
extracting, by an AI entity extractor, entities from the plurality of differently-classified groups of data;
creating, using a frequency analysis engine and from the extracted entities, a frequency distribution table identifying how frequently types of non-compliance are contained within the web accessibility incident data;
generating, using the frequency distribution table and by an ensemble engine, a web accessibility meta-analysis; and
providing the web accessibility meta-analysis to an accessibility checker, wherein
the web accessibility meta-analysis is used to modify operations of the accessibility checker, and
the one or more AI foundation models includes the AI classifier and the AI entity extractor.

16. The computer program product of claim 15, wherein
the web accessibility incident data is classified by type of compliance violation.

17. The computer program product of claim 15, wherein
the extracted entities include web accessibility standards contained within the web accessibility incident data.

18. The computer program product of claim 15, wherein the computer hardware system is further configured to perform:
generating, using a AI summarizer, a summary for each of the differently-classified groups of data, wherein
the web accessibility meta-analysis is generated using the summary for each of the differently-classified groups of data, and
the one or more AI foundation models includes the AI summarizer.

19. The computer program product of claim 18, wherein
the entities extracted by the AI entity extractor are used by a web accessibility standards agent to identify documentation describing web accessibility standards associated with the entities, and
the AI summarizer uses the documentation to generate the summary.

20. The computer program product of claim 15, wherein
a web asset analyzed by the accessibility checker is subsequently modified based upon an analysis performed by the accessibility checker.
